(19) United States
(12) Patent Application Publication
(10) Pub. No.: US 2009/0306825 A1
(43) Pub. Date: Dec. 10, 2009

(54) MANIPULATION SYSTEM AND METHOD

(76) Inventors: Ying Li, Bridgewater, NH (US); Justin C. Keesling, Vail, AZ (US); James English, Newton, MA (US); Neil Tardella, West Haven, CT (US)

Correspondence Address: HOLLAND & KNIGHT LLP, 10 ST. JAMES AVENUE, BOSTON, MA, 02116-3889, US

(21) Appl. No.: 12/427,193

(22) Filed: Apr. 21, 2009

Related U.S. Application Data
(60) Provisional application No. 61/124,775, filed on Apr. 21, 2008.

(51) Int. Cl. G05B 15/02

(52) U.S. Cl. 700/261

(57) ABSTRACT

A method, computer program product, and system for robotic manipulation is provided. The method may include receiving, at a computing device, an input indicating an existence of an object having at least one characteristic and identifying the at least one characteristic via the computing device. The method may further include determining a robotic manipulating algorithm for the object based upon, at least in part, the at least one characteristic, the robotic manipulating algorithm defining instructions for enabling a robot to manipulate the object. Numerous other embodiments are also within the scope of the present disclosure.

### RELATED APPLICATIONS

This application claims the priority of the following application, which is herein incorporated by reference: U.S. Provisional Application No. 61/124,775; filed 21 Apr. 2008, entitled: “Design, Creation, and Validation of a Comprehensive Database Infrastructure for Robotic Grasping.”

### GOVERNMENT LICENSE RIGHTS TO CONTRACTOR-OWNED INVENTIONS MADE UNDER FEDERALLY SPONSORED RESEARCH AND DEVELOPMENT

The U.S. Government has a paid-up license in this invention and the right in limited circumstances to require the patent owner to license others on reasonable terms as provided for by the terms of NASA contract NAS 9-02091.

### TECHNICAL FIELD

This disclosure generally relates to robotic systems and methods. More specifically, the present disclosure is directed towards real-time robotic manipulation techniques allowing for the manipulation of numerous objects of varying sizes and shapes.

### BACKGROUND

Grasping and manipulating objects is one of the most important capabilities needed for a robot to interact with the world. In fact, the deficiencies of traditional grasping techniques are generally considered a primary obstacle to wide adoption of robots. In the past, many techniques have been proposed for grasping, including control-based methods, Jacobian Techniques, dynamic programming, the use of prototypes, human demonstration, State Vector Machines, shape primitives, and the optimization of distance metrics, among many others. These methods have had some specific success in the lab, but automatic generic grasping in the field is still out of reach. One of the best examples of successful generic grasping is that of humans and manipulative animals. Though the functioning of mammalian brains transcends human understanding, it is clear that when presented with a new object in a new context a grasp is chosen based on stored past experience with similar objects and similar context.

### SUMMARY OF DISCLOSURE

In a first implementation of this disclosure, a method includes receiving, at a computing device, an input indicating an existence of an object having at least one characteristic and identifying the at least one characteristic via the computing device. The method may further include determining a robotic manipulating algorithm for the object based upon, at least in part, the at least one characteristic, the robotic manipulating algorithm defining instructions for enabling a robot to manipulate the object.

One or more of the following features may also be included. The robotic manipulating algorithm may be selected from a plurality of robotic manipulating algorithms stored in a memory. Further, the at least one characteristic may include at least one of a position, a shape, a material property, a property of the environment, a medium, and an obstacle. In some embodiments, the memory may be an expandable tree-structured database. The method may further include performing a scan of the object.

In some embodiments the robotic manipulating algorithm may include instructions for a grasping motion. Moreover, the grasping motion may include at least one of a grasping position, a grasping trajectory, and a grasping force. The grasping force may be determined according to a force control algorithm configured operate based upon, at least in part, at least one signal received from a force sensor. The method may further include refining at least one of a grasping position and a grasping force associated with at least one of said plurality of manipulating algorithms.

In some embodiments, the characteristic may include a Computer Aided Design (CAD) model of at least one of the object and an environment of the object. The characteristic may further include a property of the environment of the object. The manipulating algorithm may utilize at least one constraint to perform the grasp and the method may be configured using Extensible Markup Language (XML).

In another implementation of this disclosure, a computer program product resides on a computer readable medium and has a plurality of instructions stored on it. When executed by a processor, the instructions cause the processor to perform operations including receiving an input indicating an existence of an object having at least one characteristic and identifying the at least one characteristic. Operations may further include determining a robotic manipulating algorithm for the object based upon, at least in part, the at least one characteristic, the robotic manipulating algorithm defining instructions for enabling a robot to manipulate the object.

One or more of the following features may also be included. The robotic manipulating algorithm may be selected from a plurality of robotic manipulating algorithms stored in a memory. Further, the at least one characteristic may include at least one of a position, a shape, a material property, a property of the environment, a medium, and an obstacle. In some embodiments, the memory may be an expandable tree-structured database. Instructions may be included allowing for a scan of the object.

In some embodiments the robotic manipulating algorithm may include instructions for a grasping motion. Moreover, the grasping motion may include at least one of a grasping position, a grasping trajectory, and a grasping force. The grasping force may be determined according to a force control algorithm configured operate based upon, at least in part, at least one signal received from a force sensor. Operations may further include refining at least one of a grasping position and a grasping force associated with at least one of said plurality of manipulating algorithms.

In some embodiments of the product, the characteristic may include a Computer Aided Design (CAD) model of at least one of the object and an environment of the object. The characteristic may further include a property of the environment of the object. The manipulating algorithm may utilize at least one constraint to perform the grasp and the method may be configured using Extensible Markup Language (XML).

In another implementation of this disclosure, a robotic manipulating system is provided. The robotic manipulating system may include a robot having at least one manipulating mechanism and a memory operatively connected with the robot. The memory may include a plurality of robotic manipulating algorithms. The manipulating system may also include a computing device configured to receive an input indicating an existence of an object having at least one characteristic, the computing device being further configured to identify the at least one characteristic. In some embodiments, the computing device may be further configured to select a robotic manipulating algorithm for the object based upon, at least in part, the at least one characteristic. The robotic manipulating algorithm may define instructions for enabling the robot to grasp the object via the at least one manipulating mechanism. In some implementations, the memory may include a tree-structured database.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an exemplary embodiment of a robotic system including a robotic manipulation process in accordance with the present disclosure;

FIG. 2 is a schematic of a tree-structured database in accordance with the robotic manipulation process of the present disclosure;

FIG. 3 is an exemplary embodiment of a database construction tool in accordance with the robotic manipulation process of the present disclosure;

FIG. 4 shows the derivation and calculation of various grasps using a Schunk hand in accordance with the robotic manipulation process of the present disclosure;

FIG. 5 shows the application of various fingertip forces to a particular object in accordance with the robotic manipulation process of the present disclosure;

FIG. 6 is an exemplary embodiment of force control system in accordance with the robotic manipulation process of the present disclosure;

FIG. 7 is another exemplary embodiment of a robotic system including a robotic manipulation process in accordance with the present disclosure; and

FIG. 8 is a flowchart depicting operations in accordance with the robotic manipulation process of the present disclosure.

Like reference symbols in the various drawings may indicate like elements.

### DETAILED DESCRIPTION OF THE PREFERRED EMBODIMENTS

Generally, the present disclosure provides a robotic manipulation process, which may utilize a database approach for robotic grasping tailored to real-time applications. The proposed algorithm database provides end-effector trajectories and forces to complete a grasp on objects of all kinds. The database may be constructed using a combination of human input, object metrics, grasp algorithms, refinement algorithms, and digital simulation. It may leverage unique control algorithms and may be described using the Extensible Markup Language (XML), with each database instantiation corresponding to one grasping mechanism, such as a pincher, hand, or pair of hands. The present disclosure includes a software system that supports the full spectrum of grasping mechanisms, from rudimentary grippers to complex cooperating hands. The focus is real-time operation, and in all cases, the database entries may provide the grasp in a fraction of a second. The database may be organized to have approximately log(N) access time, for N database entries.

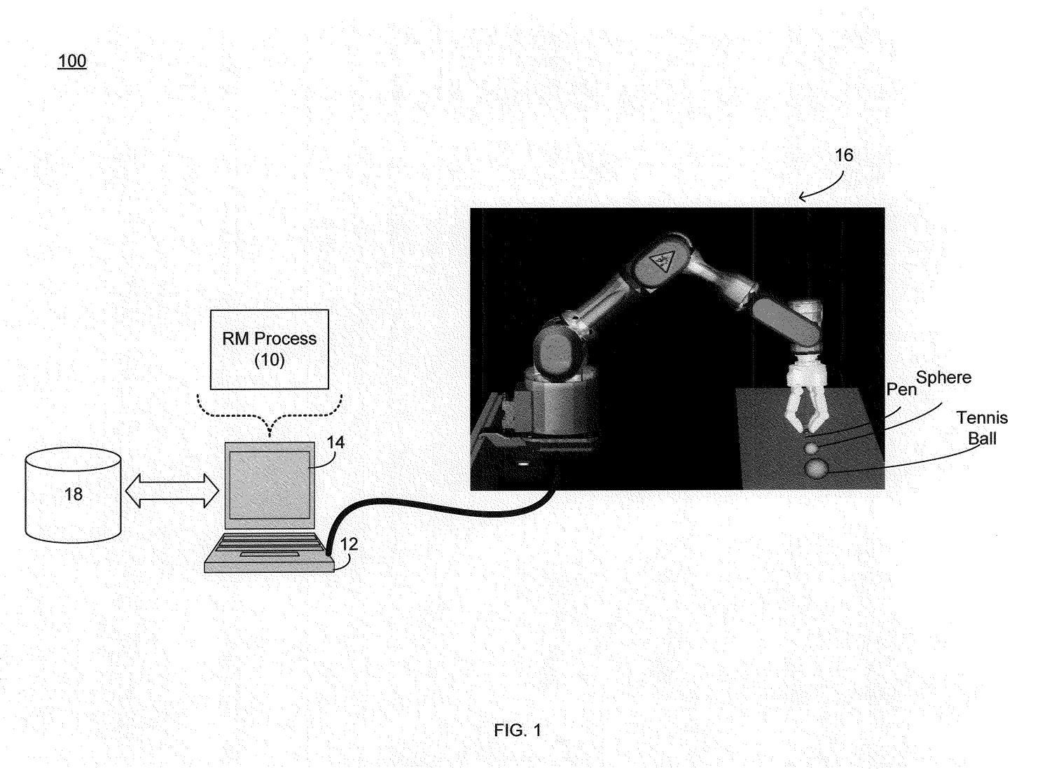

Referring to FIG. 1, there is shown a robotic manipulation (i.e., RM) process 10, which may be resident on (in whole or in part) and executed by (in whole or in part) computing device 12 (e.g., a laptop computer, a notebook computer, a single server computer, a plurality of server computers, a desktop computer, or a handheld device, for example). Computing device 12 may include a display screen 14 for displaying images associated with RM process 10. Computing device 12 may be configured to communicate with robot 16 using any suitable communication technique such as wired and wireless communication methodologies known in the art.

The terms “manipulate”, “manipulating”, “manipulation” and the like, as used herein, may refer to any and all forms of grasping, moving, operating and/or any treatment of an object using mechanical devices.

As will be discussed below in greater detail, RM process 10 may be executed by computing device 12 and may allow robot 16 to manipulate numerous objects of varying sizes and shapes (e.g., the pen, sphere, and tennis ball shown in FIG. 1). Computing device 12 may execute an operating system (not shown), examples of which may include but are not limited to Microsoft Windows XP™, Microsoft Windows Mobile™, Apple Max OS X, Wind River Systems VxWorks, and Redhat Linux™. The instruction sets and subroutines of RM process 10 and the operating system (not shown), which may be stored on a storage device 18 coupled to computing device 12, may be executed by one or more processors (not shown) and one or more memory architectures (not shown) incorporated into computing device 12.

Storage device 18 may include, but is not limited to, a hard disk drive, a tape drive, an optical drive, a RAID array, a random access memory (RAM), or a read-only memory (ROM). Storage device 18 may be configured to store a plurality of robotic manipulating algorithms, which may define instructions for enabling a robot to manipulate a particular object.

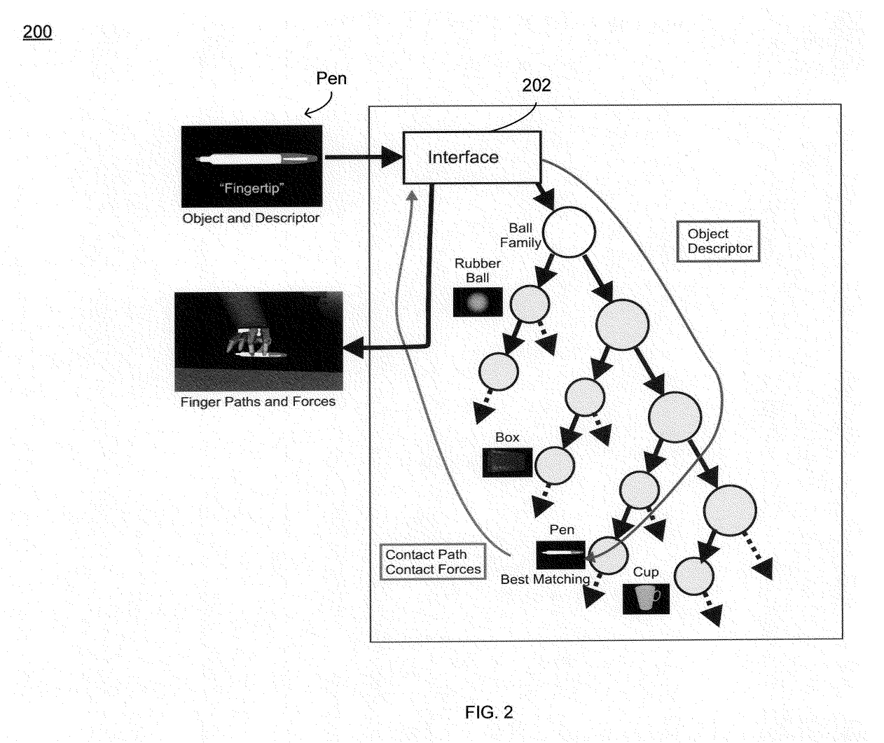

Referring now to FIG. 2, the plurality of algorithms may be stored within database 200 associated with storage device 18, which may be organized in a tree-structure. Database 200 may be configured to receive an input indicating an existence of an object having at least one characteristic. The term “characteristic” as used herein may refer to any suitable descriptor of an object and/or the object's environment. These descriptors may include, but are not limited to, the object's position, color, size, shape and/or material properties. For example, a characteristic associated with an object may include a three dimensional (3D) representation of the object in a form corresponding to that used by a Computer Aided Design (CAD) software program such as SolidWorks, Pro/Engineer, or AutoCAD, and this CAD representation may use an XML format.

In some embodiments, a characteristic of the object may relate to the environment of the object. Referring to FIG. 1, the table beneath the pen, sphere, and tennis ball shown provides a support surface, and its description forms a characteristic of the object to be grasped. Other example support surfaces and structures whose description may form an object characteristic may include, but are not limited to, terrestrial soil, a building floor, furniture, factory conveyors and shelves, doors, windows, roads, water, plants, trees, and planetary and lunar surfaces.

In some embodiments, a characteristic of the object may relate to the medium in which the object resides. The medium could be, for example, air, water, or vacuum. In some embodiments, a characteristic of the object may include obstacles that may possibly impede the motion of a robotic system performing a manipulation and/or grasp. For example, and referring again to FIG. 1, the tennis ball is an obstacle that may prevent the robotic system from grasping the sphere. Other obstacles could include, for example, limbs on a tree, rocks, walls, furniture, objects similar to the object to be grasped, objects covering or holding down an object, containers, other robots, animals, and human beings.

In some embodiments, a scan (e.g., three-dimensional) of a particular object may be performed, for example the pen shown in FIG. 2. The results of the scan may be provided to interface 202 of algorithm database 200 as a computer-aided design (CAD) model.

In operation, the tree-structure approach shown in FIG. 2 may enable the most suitable robotic manipulation algorithm to be selected for a particular object. In this way, RM process 10 may be capable of matching, for example, the shape, articulation, and surface properties of the object to be manipulated. Each leaf node in the tree may provide a specific algorithm whose implementation may be limited only by the interface structure and a programming language such as, but not limited to, C, C++, C#, Python, or Java. The algorithm may be stored as interpreted source code or as binary executable. Each branch node may implement a fast comparison method to eliminate large portions of the tree below it or it may eliminate portions of the tree below it based on analysis of results returned from said portions of the tree. For example, the pen may bypass the ball family and the box family until determining that the pen family is the best match. RM process 10 may then determine the most suitable robotic manipulating algorithm for the object based upon the characteristics associated with the object, in this case, the shape, material properties, etc., of the pen. The robotic manipulating algorithm may define instructions for enabling a robot, such as robot 16 shown in FIG. 1, to manipulate a particular object.

In some embodiments, the tree structured database shown in FIG. 2 may be expandable, thus providing for virtually unlimited growth, as new algorithms for new shapes may be added without disturbing existing algorithms or adding significant unwanted computational cost. The input to the database may include any number of characteristics, including for example, an object description and a manipulation or grasp-type descriptor. When an object is given, a sequence of increasingly narrow families may be identified using the object descriptor, shape, and/or surface properties. The output of database 200 after this search may include a set of finger paths and forces. An advanced new language based on XML was designed and used to represent this database.

In some embodiments, portions of the manipulating algorithms described herein may use motion constraints to implement RM process 10. These constraints may be, for example, placement of a point on a finger or link of the robotic system, orientation of a finger or link, the center of mass of the robotic system, or the motion of a mobile platform supporting the manipulator. The manipulating algorithms associated with RM process 10 may optimize secondary criteria subject to these constraints. These secondary criteria may include, for example, obstacle avoidance, self-collision avoidance, joint limit avoidance, strength optimization and accuracy optimization. A secondary criterion may also be formed by weighting and combining multiple criteria.

In some embodiments, RM process 10 may use the manipulator Jacobian equation:

V=J(q)\dot{q}, (Equation 1)

where V is an m-length vector representation of the motion of constraints (such as point, orientation, and center of mass); q is the n-length vector of robot joint and mobile base positions (with q being its time derivative); and J is the m×n manipulator Jacobian corresponding to the constraints, a function of q. When the manipulator is kinematically redundant, the dimension of V is less than the dimension of q (m<n), and (A) is underconstrained when V is specified. To calculate \dot{q} given V, a robotic manipulation algorithm may use a scalar α, a matrix function W(q), and a vector function F(q) to solve for \dot{q} through the following formula:

$$\dot{q} = {[ \frac{J}{{N}_{J}^{T} W} ]}^{- 1} [ \frac{V}{- α {N}_{J}^{T} F} ] . \qquad ( Equation 2 )$$

Here, N_{J} is an n×(n-m) set of vectors that spans the null space of J. That is, JN_{J}=0, and N_{J} has rank (n-m). By changing the values of α, W, and F, many behaviors can be implemented. Equation (2) may minimize the general quadratic function 1/2\dot{q}^{T}W\dot{q}+\dot{q}^{T}F subject to achieving V. When F is the gradient of a scalar function, this may provide damped minimization of the function.

In some embodiments, the robotic manipulating algorithms described herein may include instructions for a particular grasping motion. For example, the grasping motion may include at least one of a grasping position, a grasping trajectory, and a grasping force as is discussed in further detail hereinbelow.

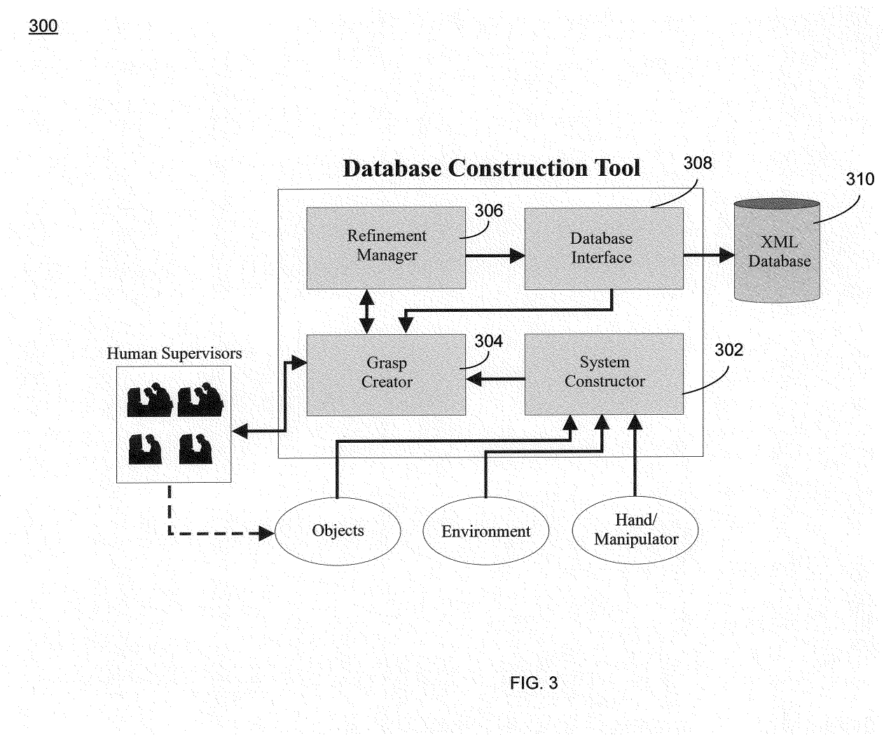

Referring now to FIG. 3, an exemplary database construction tool 300 for building the grasp-algorithm database described above is provided. The tool may be able to build a new database from a hand/manipulator description, a set of objects, and a set of environments. Database construction tool 300 may include, inter alia, system constructor 302, grasp creator 304, refinement manager 306, and database interface 308. Each of these components will be discussed in further detail hereinbelow.

In some embodiments, system constructor 302 may be configured to create a three-dimensional model that may represent the hand, manipulator, environment, and new object instances. System Constructor 302 may support all robots, hands, and environmental objects, which can be kinematically redundant or bifurcating, and may include numerous types of joints, including but not limited to, rotational, prismatic, cylindrical, four-bar, and others. Objects may be grouped and may move freely or be attached to the environment. The manipulator, hand, environment, and objects to be manipulated may all use the same software representation and data structure. The framework may support articulated and morphing links enabling the system to be scaled to support articulated, flexible, soft, and fragile objects-chains, rope, pillows, and glasses, for instance, may be grasped and/or manipulated.

As discussed above, database construction tool 300 may further include grasp creator 304, which may support the creation of new grasps (in the case of completely novel objects) or refinement of existing grasps (in the case of grasps to similarly shaped objects already existing in the database). For a new object, a grasp for a similar object may be searched for in the database using a matching metric. In an intuitive and repeatable procedure, the found grasp may be presented to the supervisor, and the grasp may be defined through both the grasping kinematic and dynamic components of the hand. Completely new grasps may be generated using a process supervised by human supervisors if a similar object and its grasp cannot be found from the database. The new grasp may then be added to the database as the initial grasp for the new object.

Grasp creator 304 may further include a software interface. The software interface may be configured to allow a user to construct a new grasp. For example, a particular grasp may be generated using joint control sliders and an intuitive configuration interface. In this way, joint positions and orientations may be set through sliders, mouse movement, and numerical configuration. The position and orientation of the wrist may also be controlled by changing the values of x, y, z, yaw, pitch, and roll using the intuitive configuration interface. The grasp may also be defined as fingertip positions in world coordinates or relative to other parts of the hand, such as the palm. Hand locations, fingertip positions, and joint angles may all be controlled automatically or directly by human supervisors during grasp database construction.

Grasp creator 304 and other portions of database construction tool 300 may work in conjunction with a variety of input devices that may interface with grasp creator 304 and support rapid creation of grasping database 310. For example, some input devices may include, but are not limited to, wired gloves such as the P5 sensing glove, the Polhemus tracker available from Polhemus Inc. of Colchester, Vt., and the SpaceNavigator available from 3DConnection of Fremont, Calif. The input framework for grasp control based on these input devices may be flexible and generic. With these input devices the human supervisor may use the best device for each stage to control the hand model in the virtual environment and to move and pre-shape the hand for creating grasps.

Once a hand grasp is selected from database 310 or generated through the supervision interface, it may be aligned to the object shape. One goal of the alignment process is to find a transformation to be applied to the hand pose so the desired contact points on the hand are brought into correspondence with points on the object. Grasp alignment algorithms of this type have been developed for use in the framework.

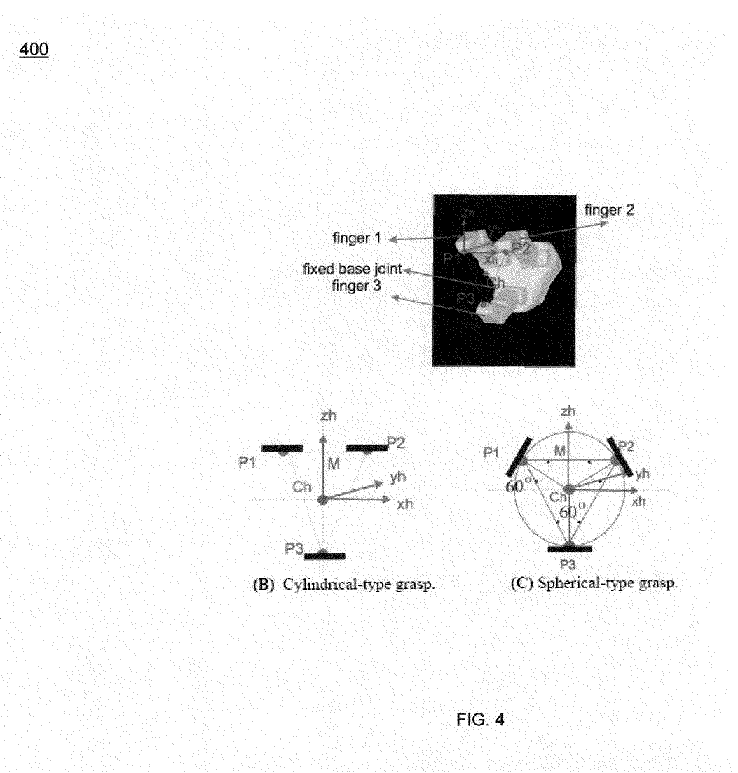

Referring now to FIG. 4, exemplary grasps for near spherical and near-cylindrical objects using fingertips are provided for the Schunk Anthropomorphic hand (SAH) available from Schunk GmbH & Co. The idea is to align the grasp geometry center of the hand to the geometry center of the object to be grasped. FIG. 4 shows three contact points P1, P2, and P3 in the palm frame as derived for the SAH. A frame (Xh, Yh, Zh) is generated from the three contact points. The Xh axis direction may be the same as the line P1P2, and the Yh direction is pointing toward the palm from the triangle. Zh may be determined by Xh and Yh. The origin of the frame may be selected as the point P1. For a cylindrical grasp, Ch, the geometry center, may be calculated as

$${C}_{h} = \frac{1}{4} P 1 + \frac{1}{4} P 2 + \frac{1}{2} P 3 \qquad ( Equation 3 )$$

For a sphere grasp, Ch may be calculated as

$${C}_{h} = \frac{1}{3} P 1 + \frac{1}{3 } P 2 + \frac{1}{3} P 3 \qquad ( Equation 4 )$$

This tailored approach may serve as a component in one of the many algorithms used to build the database shown in FIG. 2.

Database construction tool 300 may further include refinement manager 306, which may be configured to modify an idealized grasp for a generic shape for specific object variations, such as those corresponding to differences in characteristics (e.g., surface properties, shape, etc.). In some embodiments, this may involve position refinement, e.g., repositioning the fingers of the robot being used (e.g., Schunk hand) or performing other suitable adjustments. Refinement manager 306 may perform actual or approximate force closure algorithmically through repositioning the contacts associated with the robot and adjusting forces. Refinement manager 306 may be used in accordance with a variety of robotic devices, such as the Schunk hand described above, Robonaut, etc.

As discussed above, refinement manager 306 may include both grasping and force refinement capabilities. For example, refinement manager 306 may perform grasping refinement upon grasping position and force using high fidelity dynamic simulation software. First, an idealized grasp may be created, then this idealized grasp may be refined using the exact object description. A three-dimensional visualization tool may be used for grasp creation and validation.

For example, a robotic hand may have several constrained fingers with active joints which may be capable of exerting force on the object to be grasped. The grasp modes may be classified into different grasp configurations, including, but not limited to, fingertip grasps, whole hand grasps, etc. A fingertip grasp mode may be used when grasping a small object or when manipulating the object in a dexterous manner, having a small contact area at each fingertip. Alternatively, the whole hand grasp mode may be used when grasping a large object or when applying a large force to the object. Whole hand grasping may provide a large contact area between the hand and the object. In some embodiments, in order to create the fingertip grasp, the fingers may apply forces to the object through contact points. The contact points at the fingertip may exert any directional force.

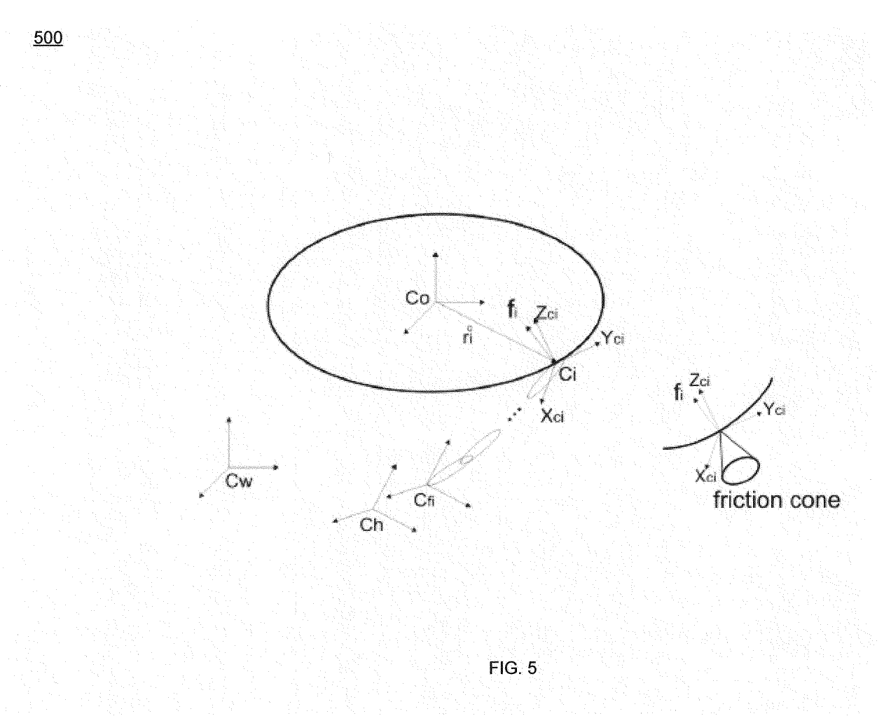

After selecting nominal force values, it may be necessary to modify them based on the exact object shape. A force refinement algorithm for fingertip grasping has been developed. In the force refinement algorithm, it may be assumed that the fingers apply forces to the object through the fingertip contact points shown in diagram 500 of FIG. 5.

Let the contact force of the hand be

fₕ=[f₁f₂ . . . fₘ]^{T}εR^{3mx1} (Equation 5)

Where

fᵢ=[fᵢₓf_{iy}f_{iz}]^{T} (Equation 6)

Again, as discussed previously, the contact points at the fingertips may exert any directional forces. If the external force is defined as Fe, equilibrium equations for an object may be written as

Gfₕ+Fₑ=0 (Equation 7)

where G is the grasp matrix. To achieve a stable grasp, it is expected that all the applied finger force directions are close to the contact normal of the object. This may allow an objective function for minimization to be defined as follows:

$$μ = - {\sum }_{i = 1}^{m} {w}_{i} \frac{{f}_{iz}}{{f}_{imax}} \qquad ( Equation 8 )$$

Where wi is the weight for finger i. As an example, a higher weight may be given for thumb, index, and middle fingers than for pinky and ring fingers. For force calculation, the criterion function in Equation 8 may be optimized subject to Equation 7, friction specifications, force direction constraints, and limitations on the force angle. For a whole hand grasp, the object may be enveloped by the hand. There may be many contacts between the hand and object. It may not be necessary to refine the contact force over each contact to ensure individual stability. A software interface may be used to refine whole-hand grasps based on force balancing rules. For many cases with a soft hand force refinement may be implemented through positioning rules.

Alternatively, whole hand grasps may have the middle links of the fingers and palm contacting the object. The forces exerted at such contact points may be a powerful phenomena to leverage for grasping. If no sensors are present those contact points may be regarded as passive contact points and the forces exerted are regarded as passive contact forces. Based on this premise a force control class may be designed using only the thumb as an active contact point to apply force, while position control may be applied to the other fingers and the palm. We tested applying active force with this algorithm to grasp a variety of objects. Simulation results showed that various successful grasps can be achieved with this approach. For a good grasp pose, when the active force is applied to the object through the thumb, the passive forces may be exerted at other contacts and automatically balance the active force and external force (for example, gravity) to generate a successful grasp.

Database construction tool 300 may also include a database interface 308. Database interface 308 may include, inter alia, a shape matching algorithm. In this way, when a new object is given, using the XML-based language, the grasp for that object or a similar object may be found in the database using a matching metric. This metric may combine any or all characteristics associated with the object, such as, shape, articulation properties, and surface properties. One possible approach may be to condense the object description into a set of keys based on the most important properties of the object. The keys may be defined using a variety of algorithms, including articulation analysis, and shape analysis. A feature-based method for whole object shape matching may also be utilized. The algorithm may rely on both surface properties and the distance and angle between surface points.

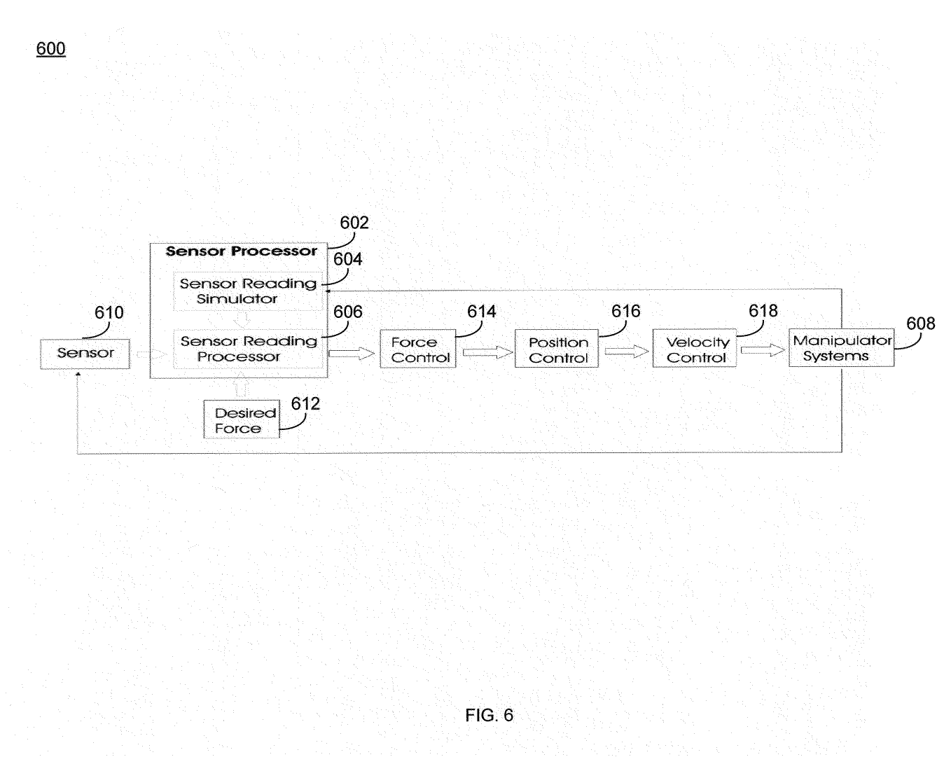

Referring now to FIG. 6, RM process 10 may work in conjunction with a grasping force control system 600. Control system 600 illustrates an exemplary force control system used in accordance with database 200 shown in FIG. 2. Sensor processor 602 may be configured to work with both hardware sensors and simulated sensors and may include sensor reading simulator 604 and sensor reading processor 606. Sensor reading simulator 604 may be used to model sensor readings during simulation. The model may be based on proximity measures between manipulator 608 and the environment. The appropriate grasping force may be determined according to a force control algorithm configured operate based upon, at least in part, at least one signal received from force sensor 610. The actual force that sensor 610 experiences may be calculated from the sensor reading and compared against the desired force for that sensor. The output of this module may be the difference between desired force 612 and the measured force—this value may be provided to the force control module 614. Force control module 614 may be in communication with position control 616 and velocity control 618. A high bandwidth touch sensor was modeled through digital simulation. The sensor may be attached to a link, with a known location and direction with respect to the primary frame of the link. The sensor may be represented by a union of convex shapes as part of the link to which it is attached. The proximity calculation routine may be capable of reporting the distance query to the individual shape level.

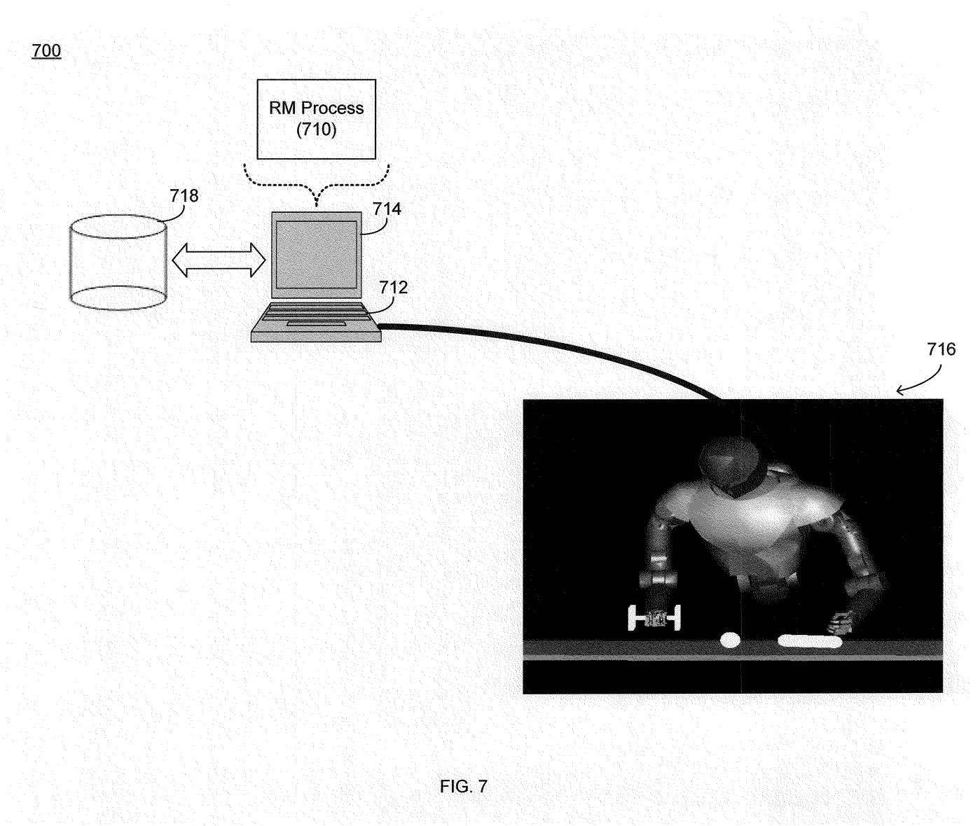

The embodiments described herein, such as those involving RM process 10 may be used in accordance with any robotic mechanism. For example, FIG. 7 depicts RM process 710 operating in conjunction with computing device 712, display screen 714, and storage device 718. However, robot 716 in this example is a NASA Robonaut. Some other robots may include but are not limited to, Schunk LWA, Mitsubishi PA-10 robotic arms, Schunk SDH hands, etc. Numerous other robotic devices, which may or may not be capable of whole hand grasps, fingertip grasps, etc., may also be used in accordance with the present disclosure.

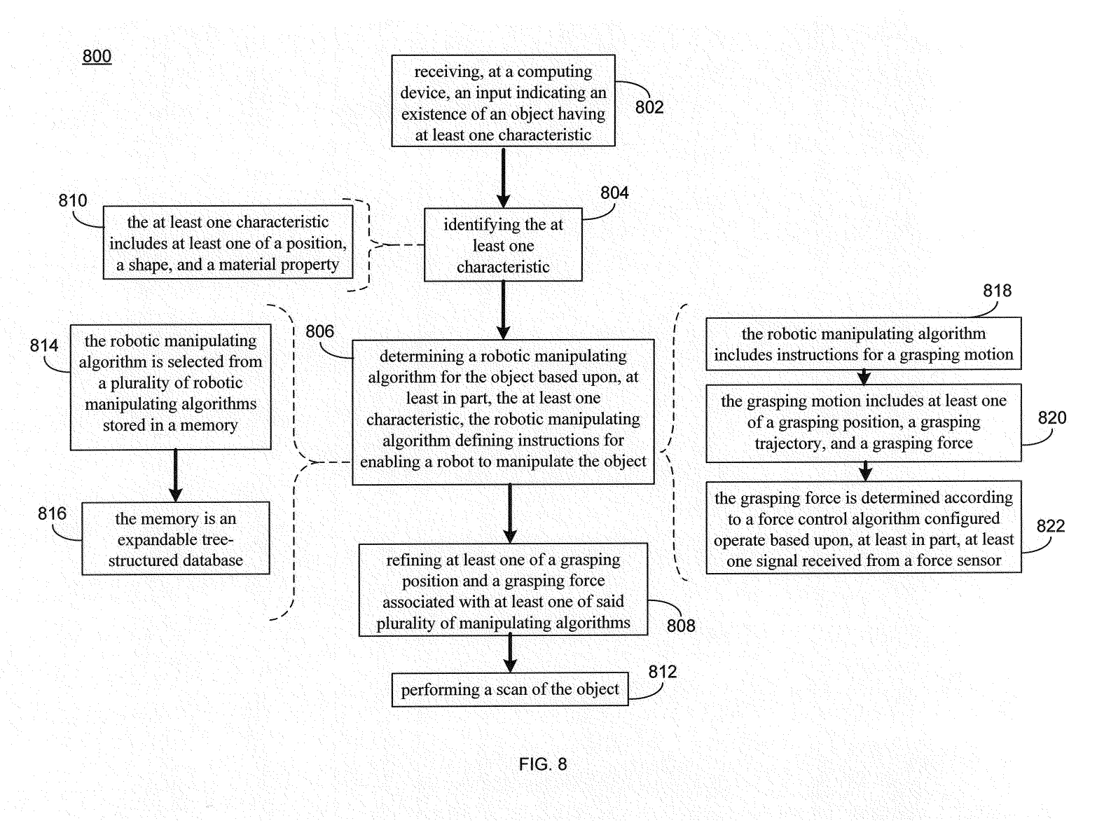

Referring now to FIG. 8, a method 800 in accordance with RM process 10 is provided. Method 800 may include determining an existence of an object having at least one characteristic (802). The method may further include identifying the at least one characteristic (804). Method 800 may also include determining a robotic manipulating algorithm for the object based upon, at least in part, the at least one characteristic, the robotic manipulating algorithm defining instructions for enabling a robot to manipulate the object (806). The method may additionally include refining at least one of a grasping position and a grasping force associated with at least one of said plurality of manipulating algorithms (808). Numerous additional operations are also envisioned without departing from the scope of the present disclosure.

The present disclosure may be used in a number of different applications. For example, the systems and methods described herein may be applied to a manufacturing setting, such as industrial robots used in industrial assembly line work. Alternatively, the subject application may be used in a military setting, for example enabling the proper handling of explosives, cutting of wires, rescue of soldiers, etc. Additionally, the concepts of the subject application may be utilized in a medical setting to assist in various medical procedures. It should be noted that these examples are provided merely as possible applications, as the teachings included herein may be applied to any device utilizing non-human manipulation.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable (i.e., computer-usable) medium(s) having computer-usable program code embodied thereon.

Any combination of one or more computer-readable medium(s) may be utilized. The computer-readable medium may be a computer readable signal medium or a computer readable storage medium. A computer-readable storage medium may be, for example, but not limited to, an electronic, magnetic, optical, electromagnetic, infrared, or semiconductor system, apparatus, a device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any medium that can contain, or store a program for use by or in connection with an instruction execution system, apparatus, or device.

A number of implementations have been described. Nevertheless, it will be understood that various modifications may be made. Accordingly, other implementations are within the scope of the following claims.

What is claimed is:

1. A computer-implemented method comprising:
receiving, at a computing device, an input indicating an existence of an object having at least one characteristic;
identifying the at least one characteristic via the computing device; and
determining a robotic manipulating algorithm for the object based upon, at least in part, the at least one characteristic, the robotic manipulating algorithm defining instructions for enabling a robot to manipulate the object.

2. The computer-implemented method of claim 1, wherein the robotic manipulating algorithm is selected from a plurality of robotic manipulating algorithms stored in a memory.

3. The computer-implemented method of claim 1, wherein the at least one characteristic includes at least one of a position, a shape, and a material property.

4. The computer-implemented method of claim 2, wherein the memory is an expandable tree-structured database.

5. The computer-implemented method of claim 1, further comprising performing a scan of the object.

6. The computer-implemented method of claim 1, wherein the robotic manipulating algorithm includes instructions for a grasping motion.

7. The computer-implemented method of claim 6, wherein the grasping motion includes at least one of a grasping position, a grasping trajectory, and a grasping force.

8. The computer-implemented method of claim 7, wherein the grasping force is determined according to a force control algorithm configured to operate based upon, at least in part, at least one signal received from a force sensor.

9. The computer-implemented method of claim 2, further comprising refining at least one of a grasping position and a grasping force associated with at least one of said plurality of manipulating algorithms.

10. The computer-implemented method of claim 1, wherein the at least one characteristic includes a Computer Aided Design (CAD) model of at least one of the object and an environment of the object.

11. The computer-implemented method of claim 1, wherein the at least one characteristic includes a property of an environment of the object.

12. The computer-implemented method of claim 1, wherein the manipulating algorithm utilizes at least one constraint to perform the grasp.

13. The computer-implemented method of claim 1, wherein the computer-implemented method is configured using XML.

14. A computer program product residing on a computer readable medium having a plurality of instructions stored thereon which, when executed by a processor, cause the processor to perform operations comprising:
receiving an input indicating an existence of an object having at least one characteristic;
identifying the at least one characteristic; and
determining a robotic manipulating algorithm for the object based upon, at least in part, the at least one characteristic, the robotic manipulating algorithm defining instructions for enabling a robot to manipulate the object.

15. The computer program product of claim 14, wherein the robotic manipulating algorithm is selected from a plurality of robotic manipulating algorithms stored in a memory.

16. The computer program product of claim 14, wherein the at least one characteristic includes at least one of a position, a shape, and a material property.

17. The computer program product of claim 15, wherein the memory is an expandable tree-structured database.

18. The computer program product of claim 14, further comprising performing a scan of the object.

19. The computer program product of claim 14, wherein the robotic manipulating algorithm includes instructions for a grasping motion.

20. The computer program product of claim 19, wherein the grasping motion includes at least one of a grasping position, a grasping trajectory, and a grasping force.

21. The computer program product of claim 20, wherein the grasping force is determined according to a force control algorithm configured to operate based upon, at least in part, at least one signal received from a force sensor.

22. The computer program product of claim 15, further comprising refining at least one of a grasping position and a grasping force associated with at least one of said plurality of robotic manipulating algorithms.

23. The computer program product of claim 14, wherein the at least one characteristic includes a Computer Aided Design (CAD) model of the object and/or the environment.

24. The computer program product of claim 14, wherein the at least one characteristic includes a property of an environment of the object.

25. The computer program product of claim 14, wherein the grasping algorithm utilizes at least one constraint to perform the grasp.

26. The computer program product of claim 14, wherein the computer-implemented method is configured using XML.

27. A robotic grasping system comprising:
a robot having at least one manipulating mechanism;
a memory operatively connected with the robot, the memory including a plurality of robotic manipulating algorithms; and
a computing device configured to receive an input indicating an existence of an object having at least one characteristic and to identify the at least one characteristic, the computing device being further configured to select a robotic manipulating algorithm for the object based upon, at least in part, the at least one characteristic, the robotic manipulating algorithm defining instructions for enabling the robot to manipulate the object via the at least one manipulating mechanism.

28. The robotic grasping system of claim 27, wherein the memory includes a tree-structured database.
